(19) United States
(12) Patent Application Publication
(10) Pub. No.: US 2025/0272159 A1
(43) Pub. Date: Aug. 28, 2025

(54) VERIFYING FAIRNESS OF WORKLOAD SHIFTING POLICIES

(71) Applicant: International Business Machines Corporation, Armonk, NY (US)

(72) Inventor: Kaustabha Ray, Bangalore (IN)

(21) Appl. No.: 18/586,000

(22) Filed: Feb. 23, 2024

(51) Int. Cl. G06F 9/50; G06F 17/18

(52) U.S. Cl. CPC G06F 9/5083; G06F 17/18

(57) ABSTRACT

A computer-implemented method according to one approach, is for determining fairness of a workload shifting policy. The CIM includes receiving execution logs from a system implementing the workload shifting policy, and inspecting the execution logs. A model is developed that replicates how the workload shifting policy is applied by the system. Moreover, a desired metric of interest is defined. A probabilistic model checker is used to evaluate the model and the desired metric of interest, and a quantitative measure of the fairness of the workload shifting policy is produced.

### BACKGROUND

The present invention relates to host workloads, and more specifically, this invention relates to applying and evaluating workload shifting policies.

Increased data production has amplified the overhead associated with performing data processing. For instance, datacenters are estimated to currently consume between 1% and 2% of total worldwide electricity generation. Moreover, this number is projected to increase to between 8% and 20% of total electricity generation by the year 2030. This is due at least in part to the rapid increase in application demand by users, the decreased ability to use Dannard scaling, etc.

While AI has been developed in an attempt to combat this rise in overhead, advancements in AI have caused the complexity of AI based learning models to increase as well. Increasingly complex models translate to more intense workloads and increased strain associated with applying the models to received data.

Cloud computing has also been implemented in an effort to improve the ability to perform resource intense operations and process an increasing amount of data. For instance, cloud locations can be tailored to provide a dynamic level of computational throughput which adjusts power consumption to meet a client's needs. Moreover, by distributing cloud computing locations in different environments and having different configurations, resource intensive workloads may be split and/or moved (e.g., shifted) to computing locations that are best suited to process the workloads. While this may prevent excessive power consumption and processing bottlenecks from developing in a distributed system, it is incredibly difficult to ensure that workloads are split and/or moved to computing locations in a consistent and desired manner.

### SUMMARY

A computer-implemented method (CIM) according to one approach, is for determining fairness of a workload shifting policy. The CIM includes receiving execution logs from a system implementing the workload shifting policy, and inspecting the execution logs. A model is developed that replicates how the workload shifting policy is applied by the system. Moreover, a desired metric of interest is defined. A probabilistic model checker is used to evaluate the model and the desired metric of interest, and a quantitative measure of the fairness of the workload shifting policy is produced.

A computer program product (CPP) according to another approach is for determining fairness of a workload shifting policy. The CPP includes a set of one or more computer-readable storage media, and program instructions. The program instructions are collectively stored in the set of one or more storage media, and are for causing a processor set to perform the foregoing CIM.

A computer system (CS), according to yet another approach, includes a processor set, and a set of one or more computer-readable storage media. The CS also includes program instructions that are collectively stored in the set of one or more storage media, for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational diagram of applying a workload shifting policy, in accordance with one approach.

FIG. 3A is a flowchart of a method, in accordance with one approach.

FIG. 3B is a flowchart of sub-processes for one of the operations in the method of FIG. 3A, in accordance with one approach.

FIG. 3C is a flowchart of sub-processes for one of the operations in the method of FIG. 3A, in accordance with one approach.

FIG. 4 is a representational diagram of a model representing a workload shifting policy, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for developing and applying a model that is configured to determining the fairness of a workload shifting policy applied in distributed (e.g., multi cloud-edge) environments. This is true even for workload shifting policies that are applied in distributed environments that involve shifting throughput across multiple different edge environments. Approaches herein are thereby able to redistribute workloads (or portions thereof) such that one or more metrics of interest are maintained at desired levels, e.g., as will be described in further detail below.

In one general approach, a CIM is for determining fairness of a workload shifting policy. The CIM includes receiving execution logs from a system implementing the workload shifting policy, and inspecting the execution logs. A model is developed that replicates how the workload shifting policy is applied by the system. Moreover, a desired metric of interest is defined. A probabilistic model checker is used to evaluate the model and the desired metric of interest, and a quantitative measure of the fairness of the workload shifting policy is produced.

In another general approach, a CPP is for determining fairness of a workload shifting policy. The CPP includes a set of one or more computer-readable storage media, and program instructions. The program instructions are collectively stored in the set of one or more storage media, and are for causing a processor set to perform the foregoing CIM.

In yet another general approach, a CS includes a processor set, and a set of one or more computer-readable storage media. The CS also includes program instructions that are collectively stored in the set of one or more storage media, for causing the processor set to perform the foregoing CIM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved workload shifting code at block 150 for developing and applying a model that is configured to determining the fairness of a workload shifting policy applied in distributed (e.g., multi cloud-edge) environments, e.g., as will be described in further detail below. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

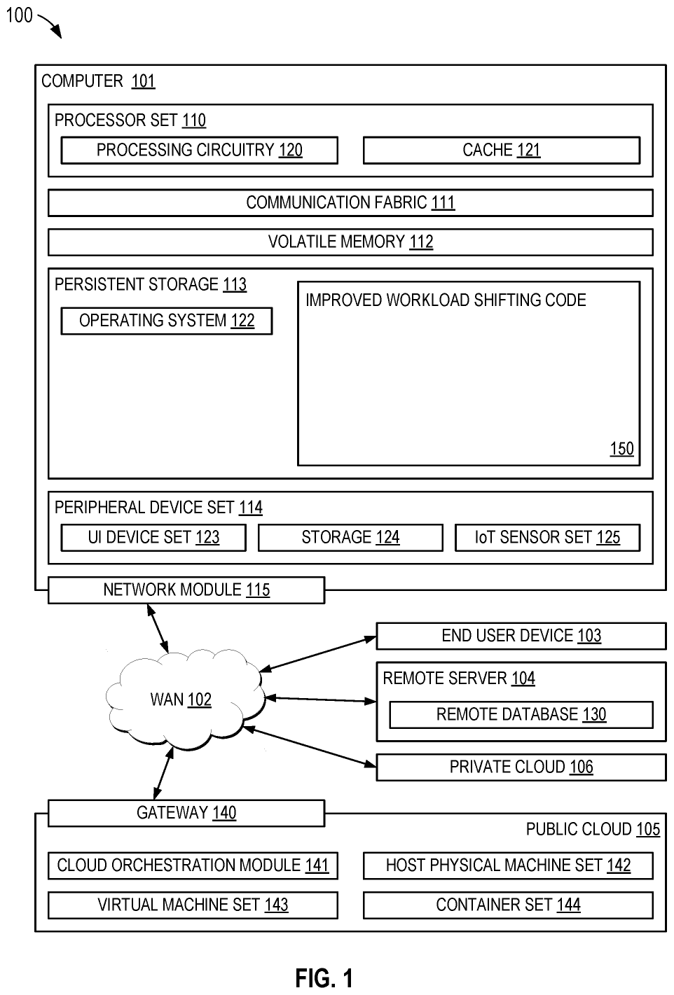

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As noted above, increased data production has amplified the overhead associated with performing data processing. For instance, datacenters are estimated to currently consume between 1% and 2% of total worldwide electricity generation. Moreover, this number is projected to increase to between 8% and 20% of total electricity generation by the year 2030. This is due at least in part to the rapid increase in application demand by users, the decreased ability to use Dannard scaling, etc.

While AI has been developed in an attempt to combat this rise in overhead, advancements in AI have caused the complexity of AI based learning models to increase as well. Increasingly complex models translate to more intense workloads and increased strain associated with applying the models to received data. The operation of conventional systems has thereby been negatively impacted.

Cloud computing has been implemented in an effort to improve the ability to perform resource intense operations and process an increasing amount of data. For instance, cloud locations can be tailored to provide a dynamic level of computational throughput which adjusts power consumption to meet a client's needs. Moreover, by distributing cloud computing locations in different environments and having different configurations, resource intensive workloads may be split and/or moved (e.g., shifted) to computing locations that are best suited to process the workloads. While this may prevent excessive power consumption and processing bottlenecks from developing in a distributed system, it is incredibly difficult to ensure that workloads are split and/or moved to computing locations in a consistent and desired manner.

However, approaches herein are desirably able to develop and apply a model that is configured to determining the fairness of workload shifting policies. This is true even for workload shifting policies that are applied in distributed environments that involve shifting throughput across multiple different edge environments. Approaches herein are thereby able to redistribute workloads (or portions thereof) such that one or more metrics of interest are maintained at desired levels. According to an example, which is in no way intended to be limiting, a shifting policy may be configured to redistribute workloads from edge servers at locations that have limited energy, to edge servers at locations that have an energy surplus. This allows for energy consumption of a distributed system having multiple edge servers to be more uniform while also avoiding downtime caused by locations that rely on renewable energy sources that are inconsistent to receive enough energy to process a workload, e.g., as will be described in further detail below.

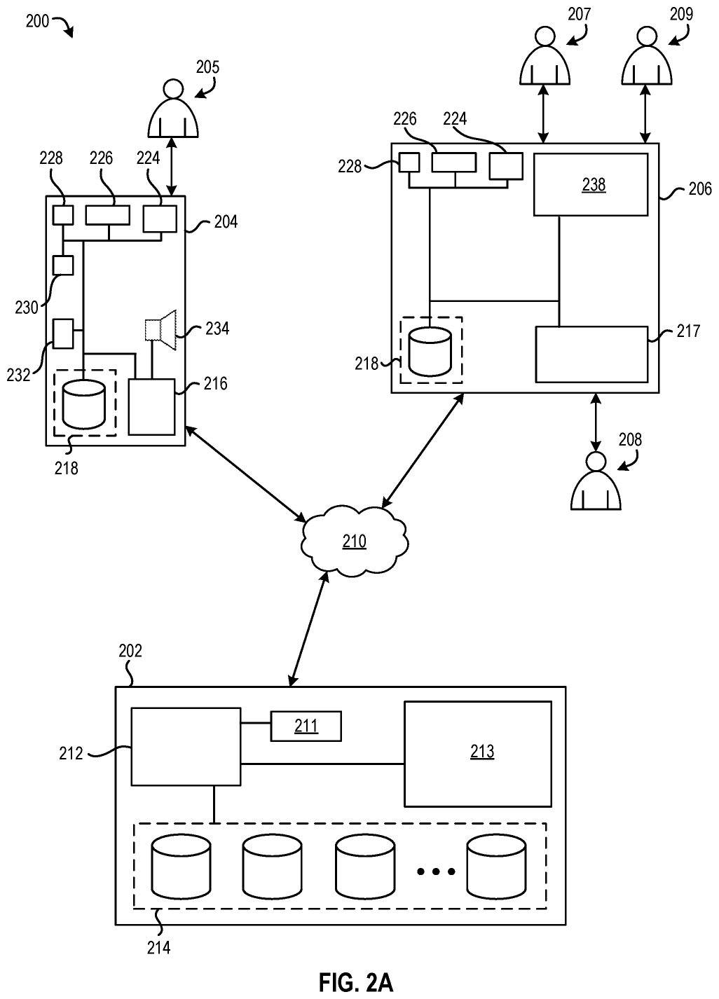

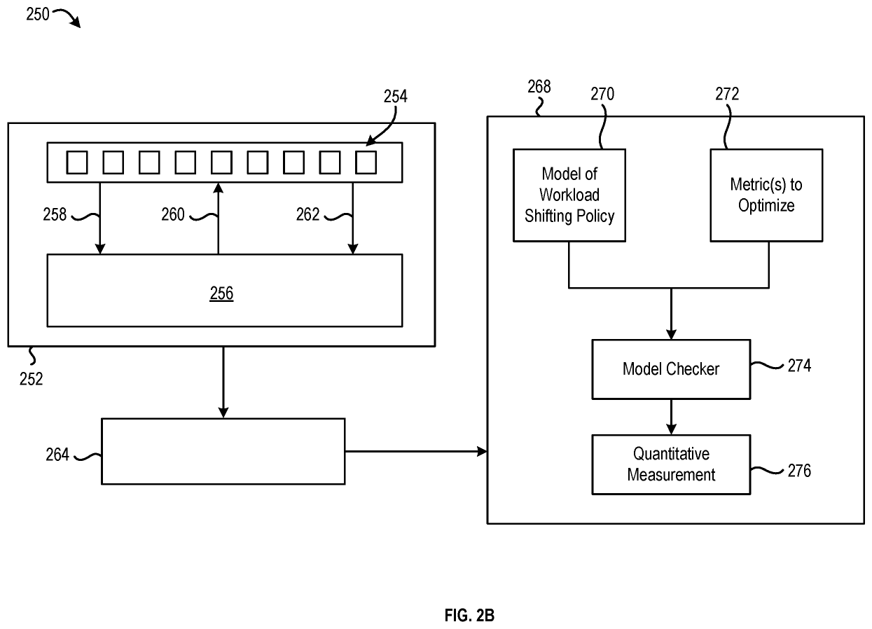

Looking now to FIG. 2A, a system 200 having a distributed architecture is illustrated in accordance with one approach. As an option, the present distributed system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the distributed system 200 includes a central server 202 that is connected to a user device 204 and edge node 206, which are accessible to users 205, 207, 208, 209, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204, edge node 206, and/or any other desired locations (e.g., nodes).

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description. It should also be noted that the term “user” is in no way intended to be limiting. While users may be described as individuals in various approaches herein, a user may be an application, an organization, a preset process, etc. The use of “data,” “datasets,” and “information” herein are in no way intended to be limiting either, and may include any desired type of details, e.g., depending on the type of operating system implemented on the user device 204, edge node 206, and/or central server 202.

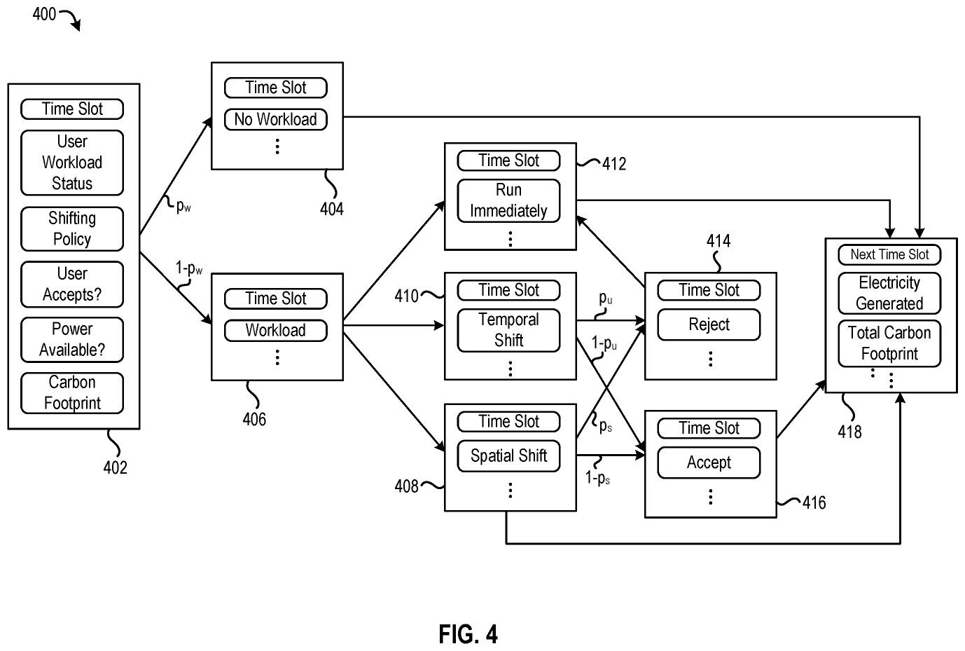

In some approaches, datasets having performance based metrics may be generated at the edge node 206 and kept at the edge node 206 to track performance. For example, execution logs of operations that are performed at the edge node 206 may be produced and retained. These execution logs may thereby be used as training data to train one or more models. For example, FIG. 4 below includes an illustrative model of a workload shifting policy that may be developed using the information in execution logs of the edge node 206. In some approaches, the execution logs are sent (e.g., copied) from user device 204 and/or edge node 206 to the central server for backup storage and/or processing using one or more AI based models (e.g., machine learning models).

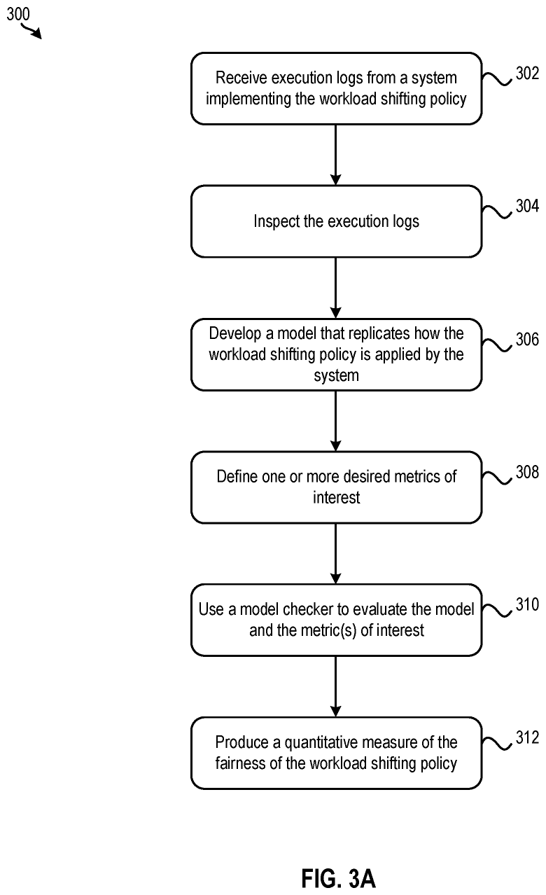

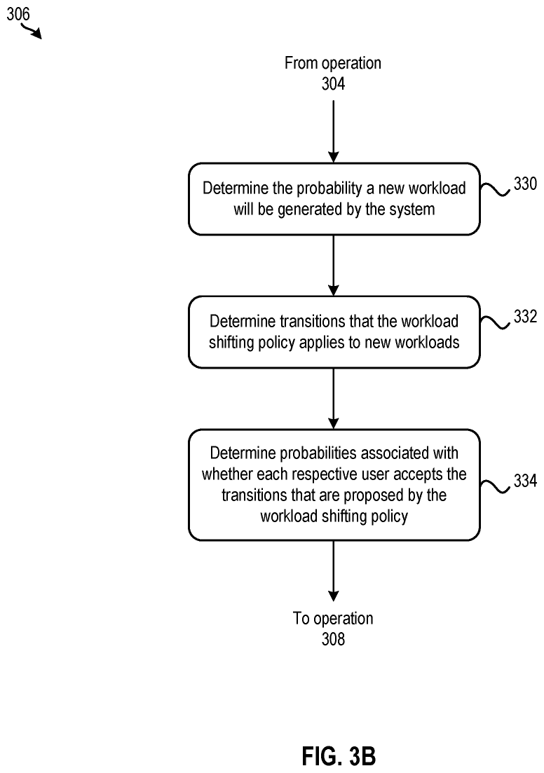

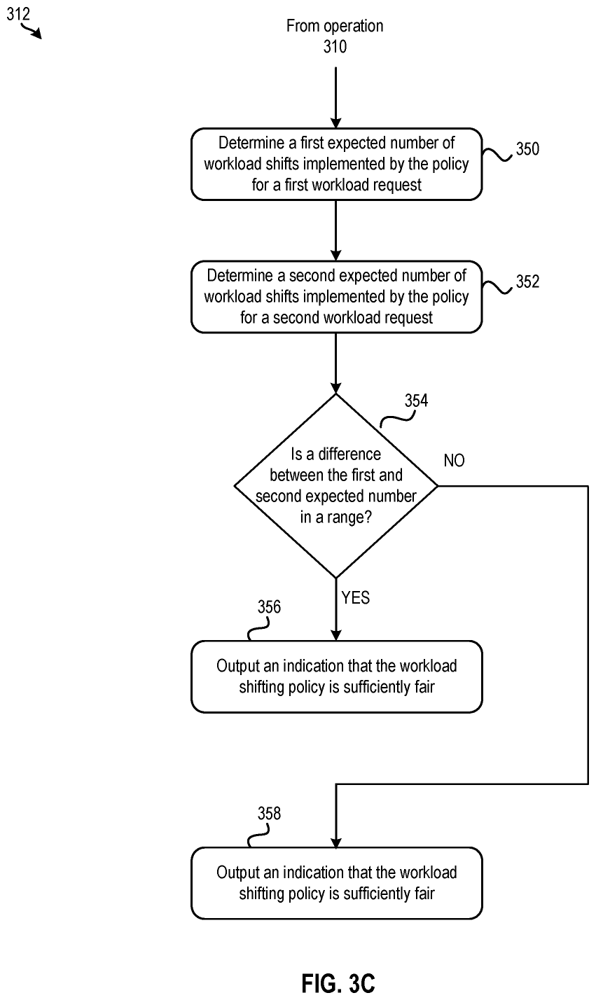

With continued reference to FIG. 2A, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 and/or processor 212 is able to interpret execution logs and develop a model that replicates how a workload shifting policy is applied by the overarching system 200. It follows that in some approaches, the AI module 213 and/or processor 212 may perform one or more of the operations in method 300 of FIG. 3A below.

With continued reference to FIG. 2A, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

As noted above, some data (e.g., execution logs) may be created in response to user 205 interacting with the electronic device 204. This data may thereby be sent to the central server 202 in some approaches for storage and/or evaluation using AI module 213. The data may be received as a result of the user 205 using one or more applications, software programs, temporary communication connections, etc. running on the user device 204.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238.

As described above with respect to AI module 213, the AI module 238 may include any desired number and/or type of AI-based models. It follows that AI module 238 may implement similar, the same, or different characteristics as AI module 213 in central server 202. In some approaches, AI module 238 and/or controller 217 are able to interpret execution logs and develop a model that replicates how a workload shifting policy is applied, e.g., by the edge node 206 itself. The execution logs may be created over time as a result of the users 207, 208, 209 using one or more applications, software programs, temporary communication connections, etc., running at the edge node 206. It follows that in some approaches, the AI module 238 and/or controller 217 may perform one or more of the operations in method 300 of FIG. 3A below.

Referring momentarily now to FIG. 2B, a representational diagram 250 illustrates how execution logs are formed and used to evaluate a workload shifting policy based on performance. It follows that present diagram 250 may be implemented in conjunction with features from any other embodiment listed herein, such as those described with reference to the other FIGS., such as FIG. 2A. However, such representational diagram 250 and others presented herein may be used in various applications and/or in permutations which may or may not be specifically described in the illustrative embodiments listed herein. Further, the representational diagram 250 presented herein may be used in any desired environment. Thus FIG. 2B (and the other FIGS.) may be deemed to include any possible permutation.

The diagram 250 includes a simplified system 252 having a number of users 254 that are connected to (e.g., communicating with) an edge site 256. The edge site 256 includes one or more processors (not shown) that are configured to implement a workload shifting policy designed to satisfy requests received from the users 254. As noted above, the workload shifting policy desirably increases the efficiency with which user requests are performed by distributing the requests such that they are performed at locations that are the best suited to do so. Although not shown, edge site 256 may be connected to a network that enables requests to be distributed to other locations that are connected to the network.

User requests 258 received at the edge site 256 are submitted to, and evaluated by, a workload shifting policy. Again, the workload shifting policy is desirably able to determine how user requests should be performed to improve overall efficiency. The workload shifting policy may even be able to tailor the redistribution of user requests such that one or more specific metrics of interest are optimized. For example, workloads received at locations that have a limited or inconsistent supply of energy may benefit from being redistributed to locations that have sufficient energy to fully process the workloads.

Based on the workloads that are received from the users 254, the workload shifting policy generates a workload execution schedule 260 which is returned to the users. The workload execution schedule 260 outlines the adjustments that should be made to how and/or where the received workloads are processed. For example, the workload execution schedule 260 may describe the temporal and/or spatial shifting that is recommended to apply to the workloads (or portions thereof) for improved performance. In response, the users 254 make determinations as to whether the workload execution schedule 260 should be implemented. Based on these determinations, the user returns decisions 262 on whether each respective portion of the workload execution schedule 260 is accepted or not. The decisions 262 returned from the users 254 thereby dictate the actions (e.g., redistribution steps) that are ultimately taken.

The actions taken as a result of the workload shifting policy produce execution logs 264 that summarize what occurred in the system 252. These execution logs 264 may accumulate in a buffer before being submitted to a processor 268 configured to perform a method and/or implement a framework that is configured to determine how fairly the workloads are being redistributed. In other approaches, the execution logs 264 are sent directly to the processor 268 as they are generated.

There, a model 270 is developed to replicate the workload shifting policy implemented at edge site 256. In other words, the model 270 is tailored to represent various details of how the workload shifting policy is applied at edge site 256, e.g., as will be described in further detail below. As shown, the model 270 is sent to a model checker 274, along with an indication 272 of what metric(s) in the policy should evaluate for fairness. The model checker 274 may thereby evaluate the model 270 while placing particular importance on specific metrics. For example, the indication 272 may outline that minimizing energy consumption is of particular importance. The model checker 274 may evaluate the model 270, along with the execution logs 264, to determine how the workloads received from users 254 are redistributed in an effort to minimize the total amount of energy consumed. The model checker 274 may be able to generate an output that provides a quantitative measurement 276 of how fairly the workload shifting policy redistributes the workloads received at edge site 256 with respect to the amount of energy that is consumed. In another example, indication 272 may outline that minimizing total carbon footprint is desired. Thus, the model checker 274 may evaluate the model 270, along with the execution logs 264, to determine a measurement 276 that conveys how well the workloads received from users 254 are redistributed in an effort to minimize total carbon footprint produced.

With respect to the present description, it should be noted that “fairness” or determining how “fair” a workload shifting policy is, is intended to refer to how uniform the performance experienced as a result of performing the workload shifting is. In other words, the fairness of a policy may be represented by a value that indicates how similar experience is for different users. Moreover, this fairness may focus on one or more specific metrics of interest. For example, the fairness of a workload shifting policy may be determined at least in part by how similar the delays experienced by each user are. In another example, the fairness of a workload shifting policy may depend at least in part on how similar the carbon footprint savings are for each user.

It should also be noted that the fairness of a workload shifting policy may involve evaluating performance over a number of iterations. In other words, running the model in a number of different situations provides supplemental information that may be used to gain a better understanding of how the policy performs. Accordingly, a workload shifting policy may be considered as being “fair” if the difference between an expected (e.g., desired) value and the actual value are in a predetermined range. In one example, a policy is determined as being fair, if for two different workload request distributions, the difference between the expected number of workload shifts is less than or equal to “ε.” This general definition may be extended to other metrics in other approaches.

Looking now to FIG. 3A, a method 300 for developing and applying a model that is configured to determining the fairness of a workload shifting policy applied in distributed (e.g., multi cloud-edge) environments is illustrated in accordance with one approach. Method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in some approaches one or more of the operations in method 300 may be partially or entirely performed by a controller in a central server (e.g., see processor 212 of FIG. 2A) that is coupled to one or more edge servers (e.g., see edge node 206 of FIG. 2A).

In various other approaches, the method 300 may be partially or entirely performed by a controller, a processor, a computer, etc., or some other device having one or more processors therein. Thus, in some embodiments, method 300 may be a computer-implemented method. Moreover, the terms computer, processor and controller may be used interchangeably with regards to any of the embodiments herein, such components being considered equivalents in the many various permutations of the present invention.

Moreover, for those embodiments having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3A, operation 302 of method 300 includes receiving execution logs from a system implementing the workload shifting policy. Operation 304 further includes inspecting the execution logs. As noted above, approaches herein are able to evaluate existing (e.g., active) workload shifting policies that have been implemented at a data storage location over time. As workload shifting policies implement changes to received workloads and how they are processed, execution logs are created. These execution logs thereby provide insight into how a workload shifting policy operates, e.g., as will be described in further detail below.

Depending on where method 300 is performed (e.g., at an edge node, at a central server, etc.), the execution logs may be received differently. For instance, in some approaches the execution logs are received in a buffer at an edge node directly from a processor causing the operations to be performed. In other approaches, the execution logs are received at a central server from an edge node where the operations being evaluated were performed.

From operation 304, method 300 advances to operation 306. There, operation 306 includes developing a model that replicates how the workload shifting policy is applied by the system. In other words, operation 306 generates a tailored model which represents various details of how the workload shifting policy is applied. The model is thereby preferably an accurate representation of how the workload shifting policy performs in any situation.

Referring momentarily to FIG. 3B, exemplary sub-operations of developing a model that replicates the inner workings of how a workload shifting policy is applied by a system are illustrated in accordance with one approach. It follows that one or more of the sub-operations in FIG. 3B may be used to perform operation 306 of FIG. 3A. However, it should be noted that the sub-operations of FIG. 3B are illustrated in accordance with one embodiment which is in no way intended to limit the invention.

As shown, sub-operation 330 includes determining the probability a new workload will be generated by the system. In other words, sub-operation 330 includes determining how likely it is that a user will submit a new workload to be processed, e.g., compared to other types of interactions with users that do not result in new workloads being generated. As previously mentioned, the probability a new workload will be generated by the system may be based at least in part on available execution logs. Thus, the execution logs evaluated in operation 304 of FIG. 3A may provide information that is used to determine the probability a new workload will be generated by the system.

In some approaches, sub-operation 330 includes developing a first probability distribution which outlines the probability of new workloads being generated. For example, a probability distribution may describe the probability that workloads of a particular type and/or size are generated. In some approaches, the probability distribution outlines the probability of a new workload being created by each of a number of users.

From sub-operation 330, the flowchart advances to sub-operation 332. There, sub-operation 332 includes determining transitions that the workload shifting policy applies to new workloads. In other words, sub-operation 332 includes determining how newly received workloads may be shifted by the policy. Depending on the approach, the workload shifting policy may implement transitions that involve temporal shifting, spatial shifting, security-based shifting, etc., or any other adjustments to how, where, when, etc. workloads are performed.

It follows that sub-operation 332 preferably evaluates execution logs over a sufficient amount of time that all possible transitions that may be implemented on a workload are identified. In some approaches, sub-operation 332 may involve evaluating a predetermined number of execution logs. The number may be predetermined by a user, based on past performance, based on the type of workload being evaluated, etc.

The flowchart advances from sub-operation 332 to sub-operation 334. There, sub-operation 334 includes determining probabilities associated with whether each respective user accepts the transitions that are proposed by the workload shifting policy. In other words, sub-operation 334 includes determining a second probability distribution that outlines probabilities for each user and whether they are expected to accept each type of proposed change to how, where, when, etc. a workload is performed.

As noted above, the probability may be determined based at least in part on available execution logs. Thus, the process of determining probabilities associated with whether each respective user accepts the transitions that are proposed by the workload shifting policy involves evaluating execution logs. Moreover, sub-operation 334 preferably evaluates execution logs over a sufficient amount of time that a sufficiently thorough understanding of how each user responds to changes that are proposed for a submitted workload. In some approaches, sub-operation 334 may involve evaluating a predetermined number of execution logs. Again, the number may be predetermined by a user, based on past performance, based on the type of workload being evaluated, etc.

It follows that the sub-operations of FIG. 3B are able to generate a model that replicates how a particular workload shifting policy is applied. The model that is generated may be a Markov Decision Process model. However, this is in no way intended to be limiting since this can be generalized by the labels and the corresponding probability distribution of the Markov Decision Process. Details of how the workload shifting policy is applied and/or how users are anticipated to respond may be used to form any type of model that would be apparent to one skilled in the art after reading the present description. For example, one or more AI based models may be developed, trained, and used to evaluate workloads that are received at a location.

Returning now to FIG. 3A, method 300 advances from operation 306 to operation 308. There, operation 308 includes defining one or more desired metrics of interest. In other words, operation 308 includes evaluating the metrics that may be optimized, and identifying one or more that the workload shifting policy should prioritize. In some approaches, operation 308 includes defining a temporal logic specification with respect to the metric(s) of interest.

Again, while the workload shifting policy is desirably able to determine how user requests should be performed to improve overall efficiency, the policy can tailor the redistribution of user requests such that one or more specific metrics of interest are optimized. Approaches herein are thereby able to redistribute workloads (or portions thereof) such that one or more metrics of interest are maintained at desired levels. According to an example, which is in no way intended to be limiting, a shifting policy may be configured to redistribute workloads from edge servers at locations that have limited energy, to edge servers at locations that have an energy surplus. This allows for energy consumption of a distributed system having multiple edge servers to be more uniform while also avoiding downtime caused by locations that rely on renewable energy sources that are inconsistent to receive enough energy to process a workload.

From operation 308, method 300 advances to operation 310. There, operation 310 includes using a model checker to evaluate the model and the metric(s) of interest. A probabilistic model checker is used to compare the model developed in operation 306 and the metric(s) of interest defined in operation 308. The model checker preferably evaluates the fairness of the model with respect to the metric(s) of interest. In other words, the model determines whether users submitting workloads have similar experiences, placing particular emphasis on the metric(s) of interest identified in operation 308. However, models may be compared to metrics of interest using other configurations which would be apparent to one skilled in the art after reading the present description.

The model checker implements probabilistic computation tree logic (PCTL). Thus, each state may be associated with a reward value that is defined in terms of the labels. The reward may be utilized in conjunction with the PCTL to obtain the quantitative measure of a given policy metric. Moreover, a reward value may be assigned to each state depending on the metric to analyze.

It follows that reward functions may be defined in accordance with metrics of interest. For example, an implementation that designates carbon footprint as a metric of interest may define a reward function that includes all carbon footprint states (e.g., values) in accordance with a model. In another example, an implementation that designates temporal shifting as a metric of interest may assign the states having a “Temporal Shifting” label a value of 1.

It follows that metrics may thereby be encoded in a PCTL with respect to the reward formulations. According to an example, the expected carbon footprint consumption until 5 pm may be represented as: R{“cfp”}_{max=?}[F timeslot=5 pm]. In another example, the expected number of user workloads that will be temporally and spatially shifted may be represented as: R{“shift”}_{max=?}[F timeslot=T]. In another example, the expected number of temporal shifts that are accepted by the user may be represented as: R{“accept”}_{max=?}[F timeslot=T]. In still another example, the minimum expected number of workload shifts associated with shifting the expected cumulative carbon footprint consumption is below 150 kg CO2eq/MWh may be represented as: multi(R{“shift”}_{min=?}[C], R{“cfp”}_{≤150}[C]).

Input parameters corresponding to the probability distribution and the model of a policy are input into a probabilistic model checker, e.g., a Probabilistic Symbolic Model Checker (PRISM), Storm, etc., to obtain a quantitative measure of the policy metric. Probabilistic model checking is a formal verification technique that provides mathematical proofs on the values derived with respect to PCTL specifications, e.g., as would be appreciated by one skilled in the art after reading the present description.

Furthermore, operation 312 includes producing a quantitative measure of the fairness of the workload shifting policy. The fairness of the workload shifting policy may be at least partially based on an output of the model checker implemented in operation 310. In other words, the fairness of the policy may be determined by comparing the experiences of users that submitted workloads. Moreover, emphasis may be placed on certain ones of the metrics of interest, e.g., depending on the desired approach.

As noted above, “fairness” as used herein is intended to refer to how uniform the performance experienced as a result of performing the workload shifting is with respect to users. In other words, the fairness of a policy may be represented by a value that indicates how similar experience is for different users. In some approaches, this fairness may focus on one or more specific metrics of interest. For example, the fairness of a workload shifting policy may be determined at least in part by how similar the delays experienced by each user are. In another example, the fairness of a workload shifting policy may depend at least in part on how similar the carbon footprint savings are for each user.

Looking to FIG. 3C, exemplary sub-operations of producing of the quantitative measure of the fairness of the workload shifting policy are illustrated in accordance with one approach. Thus, one or more of the sub-operations in FIG. 3C may be used to perform operation 312 of FIG. 3A. However, it should be noted that the sub-operations of FIG. 3C are illustrated in accordance with one embodiment which is in no way intended to limit the invention.

The sub-operations in FIG. 3C preferably involve applying the model to multiple workload requests which provides a desirably large sample size to determine the fairness of the workload shifting policy being evaluated. Moreover, users' experiences are compared to each other to determine uniformity achieved by the workload shifting policy. It follows that the sub-operations of FIG. 3C may be repeated for each unique pair of users, to determine whether the experiences of each user are sufficiently similar to each other.

For instance, sub-operation 350 includes using the model to determine a first expected number of workload shifts implemented by the policy for a first workload request or a workload request for a specific or category of users. Such a methodology is general and is characterized by the probability distribution parameter to the Markov Decision Process Model. Similarly, sub-operation 352 includes using the model again to determine a second expected number of workload shifts implemented by the policy for a second workload request. Again, applying the model to a number of different situations improves the accuracy with which the model is able to evaluate performance of the workload shift policy.

Proceeding to sub-operation 354, there the flowchart includes determining whether a difference between the first expected number of workload shifts and the second expected number of workload shifts is in a predetermined range. In other words, sub-operation 354 includes determining whether the number of workload shifts applied to the first workload and experienced by a first user, are sufficiently similar (e.g., in a predetermined range) to the number of workload shifts applied to the second workload and experienced by the second user. Again, the fairness of the workload shifting policy may be determined based at least in part on the uniformity of experiences had by the users.

Depending on the approach, the predetermined range may be set by a user, correspond to industry standards, defined by the output of one or more AI based models, based at least in part on past performance, etc. For instance, the type of metric(s) that are being evaluated to determine the fairness of the workload shifting policy may affect the predetermined range used in sub-operation 354. Moreover, it should be noted that “in a predetermined range” is in no way intended to limit the invention. Rather than determining whether a value is in a predetermined range, equivalent determinations may be made, e.g., as to whether a value is above a threshold, whether a value is outside a predetermined range, whether an absolute value is above a threshold, whether a value is below a threshold, etc., depending on the desired approach.

With continued reference to FIG. 3C, the flowchart proceeds from sub-operation 354 to sub-operation 356 in response to determining that the difference between the first and second expected numbers of workload shifts is in the predetermined range. There, sub-operation 356 includes outputting an indication that the workload shifting policy is sufficiently fair. However, the flowchart proceeds from sub-operation 354 to sub-operation 358 in response to determining that the difference between the first and second expected numbers of workload shifts is not in the predetermined range. There, sub-operation 358 includes outputting an indication that the workload shifting policy is not sufficiently fair.

In some approaches, the indication output in response to performing sub-operation 354 may be sent to an administrator assigned with maintaining the workload shifting policy. In other approaches, only outputs indicating that the policy is not sufficiently fair may be sent to the administrator. The outputs may also be output to memory where they are stored, e.g., to keep a record of how the workload shifting policy performs over time. In still other approaches, the outputs may be sent to each user that has submitted workloads processed by the policy. Users may thereby be given real-time updates to the effectiveness (e.g., fairness) of available workload shifting policies.

Looking now to FIG. 4, an illustrative model 400 of a workload shifting policy is depicted in accordance with an in-use example, which is in no way intended to be limiting. For instance, while the model 400 may serve as a Markov Decision Process model, any desired type of model may be developed and implemented, e.g., as would be appreciated by one skilled in the art after reading the present description.

Looking to the model 400, a collection of labels 402 representing the possible characteristics a workload can have, serves as a starting point. In other words, the labels represent various states at each discrete time slot that describe a workload submitted by an edge site. These “states” may include a time slot identifier, a user workload generation identifier (e.g., was a new workload submitted), a policy workload scheduling identifier (e.g., should the workload be run now or shifted spatially and/or temporally), a user workload shifting identifier (e.g., does the user accept the proposed shifts), an amount of electricity generated by renewable energy sources, and a total carbon footprint usage.

From there, the model 400 shows that there is a probability “p_{w}” that a new workload will not be generated (see labels 404), and a probability of “1−p_{w}” that a new workload will be generated (see labels 406). In situations where a new workload is not generated, labels 404 are shown as updating a running total 418 of various metrics, before evaluating a next scenario (e.g., repeating the model 400).

In situations where a workload is generated (e.g., received), the model 400 includes a number of possible transitions. Specifically, the model 400 may implement a spatial shift (see labels 408), a temporal shift (see labels 410), or no shift (see labels 412) to the generated workload. Although not shown, each of the possible shifts may also have a probability associated therewith that describes the likelihood each respective shift is suggested. For example, the user may specify one or more specific metrics for the model 400 to optimize. Thus, the chance that a given shift is implemented by the model 400 may change accordingly. In different approaches, these “transitions” may include a policy, user choices carbon footprint consumption, etc. Moreover, User Workload Generation may be a stochastic submission of workloads, while policy choices shift a workload at a different time slot, shift a workload to a different location, e.g., as described herein.

From there, the model 400 shows that there is a probability “pᵤ” that a proposed temporal shift will be rejected by the user that submitted the workload (see labels 414). There is also a probability “1−pᵤ” that a proposed temporal shift will be accepted by the user that submitted the workload (see labels 416). Similarly, the model 400 shows that there is a probability “pₛ” that a proposed spatial shift will be rejected by the user that submitted the workload (see labels 414). There is also a probability “1−pₛ” that a proposed spatial shift will be accepted by the user that submitted the workload (see labels 416).

Regardless of how model 400 progresses while evaluating a given workload and the associated shifts, the running total 418 is updated to record the results. Thus, the running total 418 is updated each time model 400 is run.

It follows that approaches herein are desirably able to improve overall performance of systems. Moreover, the probabilities are essentially the input parameters for the model, and the probabilities are derived from execution logs of a system that is implementing the workload shifting policy being evaluated for fairness. This is particularly desirable in scenarios with limited resources, e.g., such as locations that rely on renewable energy sources that are inconsistent. These improvements are also effective at overcoming situations in which user activity is unknown and/or inconsistent.

Approaches herein thereby achieve a hybrid-cloud orchestrator that is able to provide statistical insights into workload scheduling metrics with respect to different users and/or categories of users when submitting workload requests to public cloud providers. Moreover, approaches herein are highly generalizable and may extend to multi-cloud and edge environments since states can be uniquely used to identify edge sites and cloud providers.

Approaches herein are also non-deterministic and may be used for modeling policies that implement different types of shifting. These approaches also use stochasticity to model workload generation and user acceptance of workload shifting, while the labels that are used are generic and may be used to model various characteristics of the system. This desirably provides both single objective and multi-objective equivalence checking.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM) for determining fairness of a workload shifting policy, comprising:
receiving execution logs from a system implementing the workload shifting policy;
inspecting the execution logs;
developing a model that replicates how the workload shifting policy is applied by the system;
defining a desired metric of interest;
using a probabilistic model checker to evaluate the model and the desired metric of interest; and
producing a quantitative measure of the fairness of the workload shifting policy.

2. The CIM of claim 1, wherein the developing of the model that replicates how the workload shifting policy is applied by the system includes:
determining a first probability distribution which includes the probability a new workload is generated by the system;
determining transitions applied to new workloads by the workload shifting policy; and
determining a second probability distribution that includes the probabilities a user accepts each of the respective transitions.

3. The CIM of claim 2, wherein the transitions include temporal shifting and/or spatial shifting of the workload.

4. The CIM of claim 2, wherein the model that replicates how the workload shifting policy is applied by the system is a Markov Decision Process model.

5. The CIM of claim 2, wherein the transitions applied to new workloads by the workload shifting policy are determined using the execution logs.

6. The CIM of claim 1, wherein the producing of the quantitative measure of the fairness of the workload shifting policy includes:
using the model to determine a first expected number of workload shifts implemented by the policy for a first workload request;
using the model to determine a second expected number of workload shifts implemented by the policy for a first workload request; and
determining whether a difference between the first expected number of workload shifts and the second expected number of workload shifts is in a predetermined range.

7. The CIM of claim 6, further comprising:
outputting an indication that the workload shifting policy is fair in response to determining that the difference between the first and second expected numbers of workload shifts is in the predetermined range.

8. The CIM of claim 6, further comprising:
outputting an indication that the workload shifting policy is not fair in response to determining that the difference between the first and second expected numbers of workload shifts outside the predetermined range.

9. The CIM of claim 1, wherein the operations are performed by a central server, wherein the system includes one or more edge servers.

10. A computer program product (CPP) for determining fairness of a workload shifting policy, comprising:
a set of one or more computer-readable storage media; and
program instructions, collectively stored in the set of one or more storage media, for causing a processor set to perform the following computer operations:
receive execution logs from a system implementing the workload shifting policy;
inspect the execution logs;
develop a model that replicates how the workload shifting policy is applied by the system;
define a desired metric of interest;
use a probabilistic model checker to evaluate the model and the desired metric of interest; and
produce a quantitative measure of the fairness of the workload shifting policy.

11. The CPP of claim 10, wherein the developing of the model that replicates how the workload shifting policy is applied by the system includes:
determining a first probability distribution which includes the probability a new workload is generated by the system;
determining transitions applied to new workloads by the workload shifting policy; and
determining a second probability distribution that includes the probabilities a user accepts each of the respective transitions.

12. The CPP of claim 11, wherein the transitions include temporal shifting and/or spatial shifting of the workload.

13. The CPP of claim 11, wherein the model that replicates how the workload shifting policy is applied by the system is a Markov Decision Process model.

14. The CPP of claim 11, wherein the transitions applied to new workloads by the workload shifting policy are determined using the execution logs.

15. The CPP of claim 10, wherein the producing of the quantitative measure of the fairness of the workload shifting policy includes:
using the model to determine a first expected number of workload shifts implemented by the policy for a first workload request;
using the model to determine a second expected number of workload shifts implemented by the policy for a first workload request; and
determining whether a difference between the first expected number of workload shifts and the second expected number of workload shifts is in a predetermined range.

16. The CPP of claim 15, wherein the program instructions are for causing the processor set to further perform the following computer operations:
output an indication that the workload shifting policy is fair in response to determining that the difference between the first and second expected numbers of workload shifts is in the predetermined range.

17. The CPP of claim 15, wherein the program instructions are for causing the processor set to further perform the following computer operations:
output an indication that the workload shifting policy is not fair in response to determining that the difference between the first and second expected numbers of workload shifts outside the predetermined range.

18. The CPP of claim 10, wherein the operations are performed by a central server, wherein the system includes one or more edge servers.

19. A computer system (CS), comprising:
a processor set;
a set of one or more computer-readable storage media;
program instructions, collectively stored in the set of one or more storage media, for causing the processor set to perform the following computer operations:
receive execution logs from a system implementing a workload shifting policy;
inspect the execution logs;
develop a model that replicates how the workload shifting policy is applied by the system;
define a desired metric of interest;
use a probabilistic model checker to evaluate the model and the desired metric of interest; and
produce a quantitative measure of fairness of the workload shifting policy.

20. The CS of claim 19, wherein the developing of the model that replicates how the workload shifting policy is applied by the system includes:
determining a first probability distribution which includes the probability a new workload is generated by the system;
determining transitions applied to new workloads by the workload shifting policy; and
determining a second probability distribution that includes the probabilities a user accepts each of the respective transitions,
wherein the transitions include temporal shifting and/or spatial shifting of the workload,
wherein the model that replicates how the workload shifting policy is applied by the system is a Markov Decision Process model,
wherein the transitions applied to new workloads by the workload shifting policy are determined using the execution logs.
